(19) United States
(12) Patent Application Publication
(10) Pub. No.: US 2025/0196402 A1
(43) Pub. Date: Jun. 19, 2025

(54) CORE SETTING DEVICE

(71) Applicant: SINTOKOGIO, LTD., Nagoya-shi (JP)

(72) Inventor: Takashi HANAI, Nagoya-shi (JP)

(73) Assignee: SINTOKOGIO, LTD., Nagoya-shi (JP)

(21) Appl. No.: 18/973,807

(22) Filed: Dec. 9, 2024

(30) Foreign Application Priority Data
Dec. 18, 2023 (JP) 2023-213071

(51) Int. Cl. B29C 33/34

(52) U.S. Cl. CPC B29C 33/34

(57) ABSTRACT

A core setting device that sets a core in a drag disposed to face a cope in the vertical direction, includes a holding jig having a holding surface for holding the core, a rotation mechanism having a rotation shaft parallel to a first direction orthogonal to the vertical direction and configured to rotate the holding jig, and a first moving mechanism configured to move the holding jig along the first direction outside the space between the cope and the drag, wherein the holding jig moves between the outside of the space and a core setting position where the holding surface faces the upper surface of the drag in the vertical direction by rotating around the rotation shaft.

### CROSS-REFERENCE TO RELATED APPLICATION

This application is based on Japanese Patent Application No. 2023-213071 filed with Japan Patent Office on Dec. 18, 2023, the entire contents of which are hereby incorporated by reference.

### TECHNICAL FIELD

The present disclosure relates to a core setting device.

### BACKGROUND

Patent Document 1 discloses a core setting device that sets a core in a mold. This core setting device includes a rotation shaft and a core holding means provided on the rotation shaft.

### SUMMARY

The present disclosure aims to provide a core setting device that contributes to shortening the cycle time while improving the operator's workability.

The core setting device of the present disclosure is a device that sets a core in a drag disposed to face a cope in the vertical direction. The core setting device includes a holding jig having a holding surface for holding the core, a rotation mechanism having a rotation shaft parallel to a first direction orthogonal to the vertical direction and configured to rotate the holding jig, and a first moving mechanism configured to move the holding jig along the first direction outside the space between the cope and the drag. The holding jig moves between the outside of the space and a core setting position where the holding surface faces the upper surface of the drag in the vertical direction by rotating around the rotation shaft.

According to the present disclosure, a core setting device that can contribute to shortening the cycle time while improving the operator's workability is provided.

### BRIEF DESCRIPTION OF THE DRAWINGS

FIG. 1 is a perspective view showing an initial state of a molding system including a core setting device according to an embodiment.

FIG. 2 is a perspective view for explaining the operation of the molding system.

FIG. 3 is a top view showing the molding system in the state of FIG. 2.

FIG. 4 is a perspective view for explaining the operation of the molding system.

FIG. 5 is a top view showing the molding system in the state of FIG. 4.

FIG. 6 is a top view for explaining the operation of the molding system.

FIG. 7 is a top view for explaining the operation of the molding system.

FIG. 8 is a side view showing the molding system in the state of FIG. 7.

FIG. 9 is a side view for explaining the operation of the molding system.

FIG. 10 is a side view for explaining the operation of the molding system.

FIG. 11 is a side view for explaining the operation of the molding system.

FIG. 12 is a side view for explaining the operation of the molding system.

### DETAILED DESCRIPTION

Hereinafter, embodiments of the present disclosure will be described in detail with reference to the drawings. In the description of the drawings, the same elements are denoted by the same reference numerals, and redundant descriptions are omitted. The dimensional ratios in the drawings do not necessarily match those in the description. The words “upper,” “lower,” “front,” and “rear” are based on the illustrated state and are used for convenience.

### [Molding System]

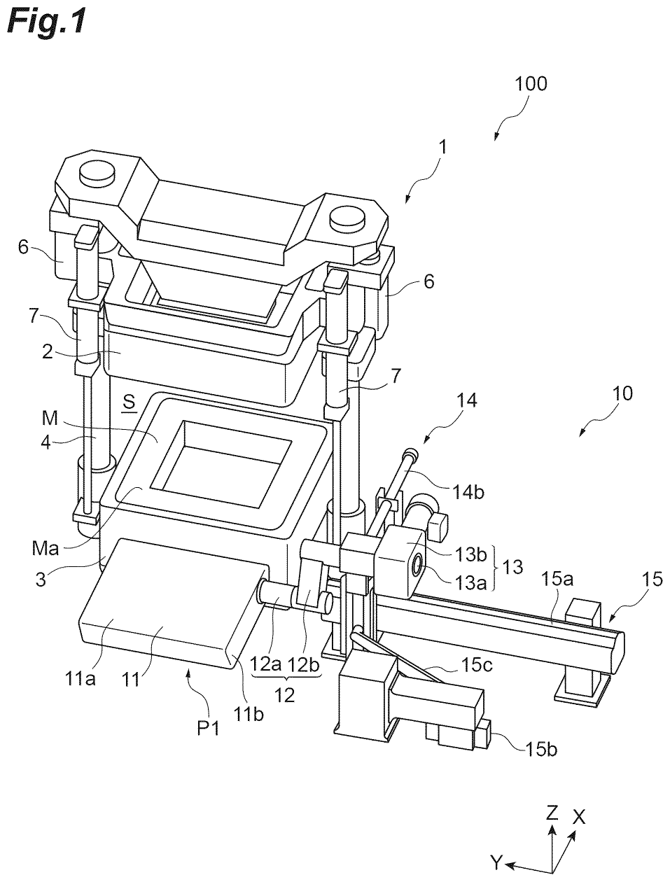

FIG. 1 is a perspective view showing an initial state of a molding system including a core setting device according to an embodiment. In the drawing, the X direction (second direction) and the Y direction (first direction) are horizontal directions, and the Z direction is a vertical direction. The X direction, Y direction, and Z direction are axial directions orthogonal to each other in an orthogonal coordinate system of three-dimensional space. Hereinafter, the X direction is also referred to as the front-rear direction, the Y direction as the lateral direction, and the Z direction as the up-down direction. The molding system 100 shown in FIG. 1 includes a cope (not shown) and a drag M, and forms a mold with a core disposed inside. The molding system 100 includes a molding machine 1 and a core setting device 10.

The molding machine 1 includes an upper flask 2, a lower flask 3, and a pair of flask guide members 4. In the initial state of the molding system 100 shown in FIG. 1, the cope and the drag M molded in the upper flask 2 and the lower flask 3 are arranged. The upper flask 2 and the lower flask 3 are disposed to face each other in the vertical direction. The cope and the drag M are disposed in the upper flask 2 and the lower flask 3, respectively, facing each other in the Z direction.

The upper flask 2 is a box-shaped frame body with open upper and lower ends and has a space inside that can accommodate a pattern disposed on the upper surface of a pattern member (not shown). The pattern member is a plate member on which a pattern can be disposed. The pattern is disposed on at least one of the upper surface and the lower surface of the pattern member. The lower end of the upper flask 2 can abut on, for example, the upper surface of the pattern member. A sand inlet penetrating from the outside to the internal space is provided in the side wall of the upper flask 2. The lower flask 3 is a box-shaped frame body with open upper and lower ends and has a space inside that can accommodate a pattern disposed on the lower surface of the pattern member. The upper end of the lower flask 3 can abut on, for example, the lower surface of the pattern member. A sand inlet penetrating from the outside to the internal space is provided in the side wall of the lower flask 3.

Each of the flask guide members 4 is a rod member that guides the upper flask 2 and the lower flask 3 and extends in the vertical direction. Each of the flask guide members 4 has, for example, a cylindrical shape. The upper flask 2 and the lower flask 3 are movably connected to the flask guide members 4. A cylinder 6 is connected to the upper flask 2 to drive the upper flask 2 in the vertical direction. A cylinder 7 is connected to the lower flask 3 to drive the lower flask 3 in the vertical direction. The cylinders 6 and 7 are, for example, hydraulic cylinders, air cylinders, or electric cylinders. The upper flask 2 and the lower flask 3 move closer to or away from each other by the movement of at least one of the upper flask 2 and the lower flask 3.

The upper flask 2 and the lower flask 3 move closer to each other by the movement of one or both of them and are coupled while clamping the pattern member. Sand is filled into the molding space of the coupled upper flask 2 and lower flask 3 through the sand inlets. The sand filled inside the upper flask 2 and the lower flask 3 is pressed toward the pattern member by an upper squeeze plate (not shown) and a lower squeeze plate (not shown). As a result, the cope and the drag M are formed. After molding the cope and the drag M, the upper flask 2 and the lower flask 3 are separated in the vertical direction, and the pattern member is unloaded, returning the molding system 100 to the initial state.

### [Core Setting Device]

The core setting device 10 is a device that sets a core (not shown) in the drag M disposed to face the cope. The core setting device 10 includes a holding jig 11, a support arm 12, a rotation mechanism 13, a front-rear moving mechanism (second moving mechanism) 14, and a lateral moving mechanism (first moving mechanism) 15. The holding jig 11 has a holding surface 11a for holding the core. The holding jig 11 has a substantially rectangular parallelepiped shape with the holding surface 11a as one face. The holding surface 11a has a rectangular shape. The thickness of the holding jig 11 (the length of the holding jig 11 in the direction orthogonal to the holding surface 11a) is shorter than compared to the long side and the short side of the holding surface 11a.

The holding jig 11, for example, has a suction means and holds the core by suction. The holding jig 11 may have a claw portion and hold the core by the claw portion.

The support arm 12 is a member that supports the holding jig 11. The support arm 12 supports the holding jig 11 in a cantilever manner. The support arm 12 includes a first portion 12a connected to the holding jig 11 and a second portion 12b connected to the rotation shaft 13a of the rotation mechanism 13. The first portion 12a is provided to protrude from the side surface 11b of the holding jig 11. The side surface 11b is a surface adjacent to one short side of the holding surface 11a. The first portion 12a is connected to one end in the short side direction of the holding surface 11a on the side surface 11b and extends in a direction parallel to the rotation shaft 13a (Y direction). The second portion 12b extends in a direction orthogonal to the rotation shaft 13a and connects the first portion 12a and the rotation shaft 13a.

The rotation mechanism 13 includes a rotation shaft 13a parallel to the Y direction and a drive unit 13b. The drive unit 13b is a motor and rotates the holding jig 11 around the rotation shaft 13a.

The front-rear moving mechanism 14 moves the rotation mechanism 13 along the X direction together with the holding jig 11 and the support arm 12. The front-rear moving mechanism 14 includes a rail member 14a and a cylinder 14b. The rail member 14a extends in the X direction. The rotation mechanism 13 is movably attached to the rail member 14a. The cylinder 14b moves the rotation mechanism 13 along the rail member 14a in the X direction. The cylinder 14b is, for example, an electric cylinder.

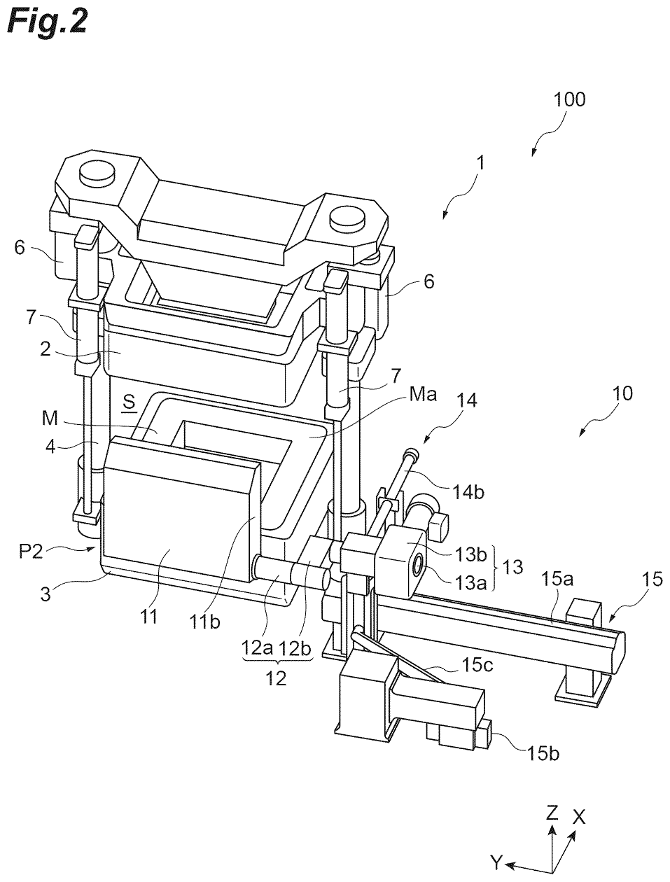

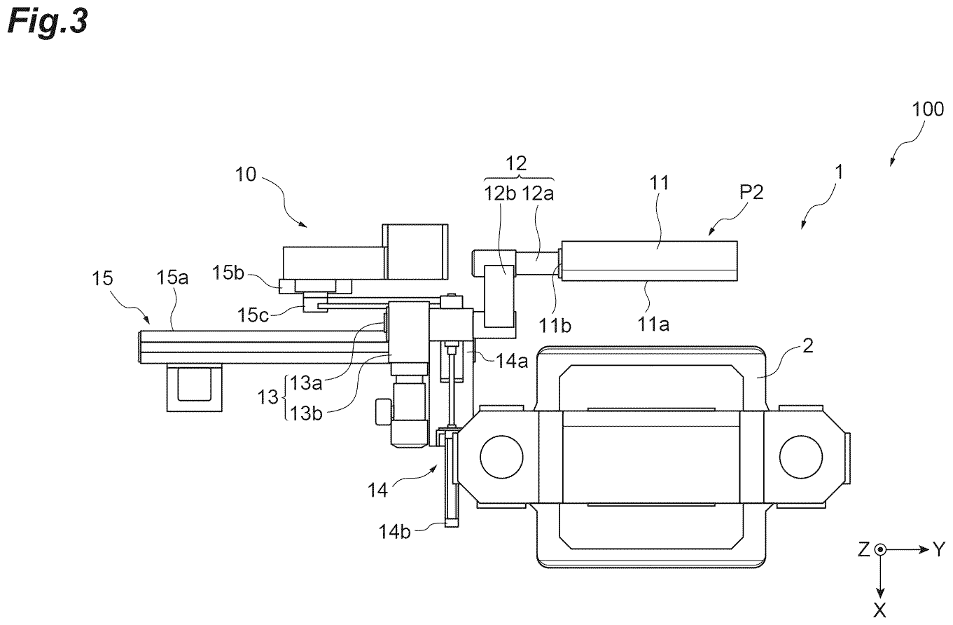

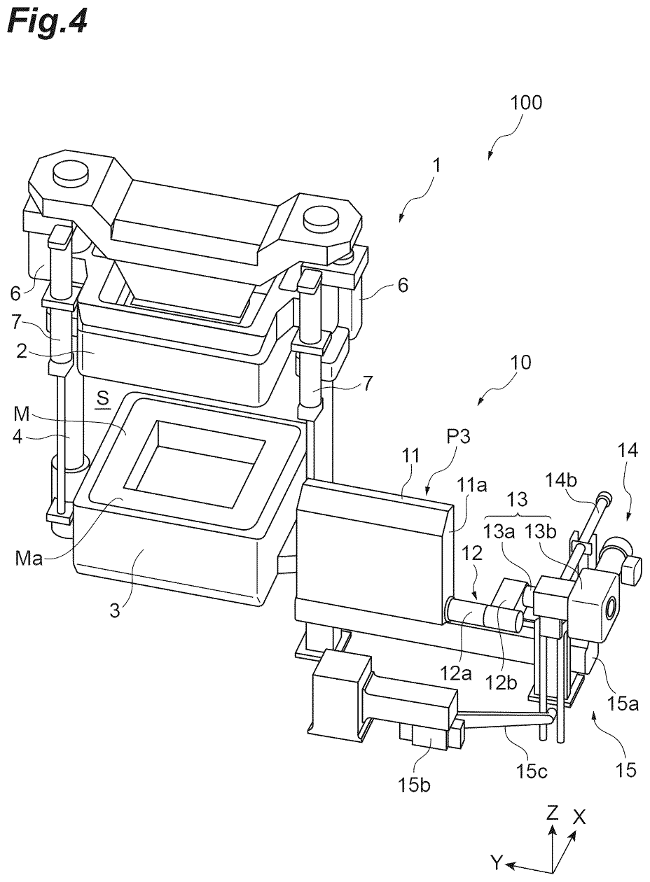

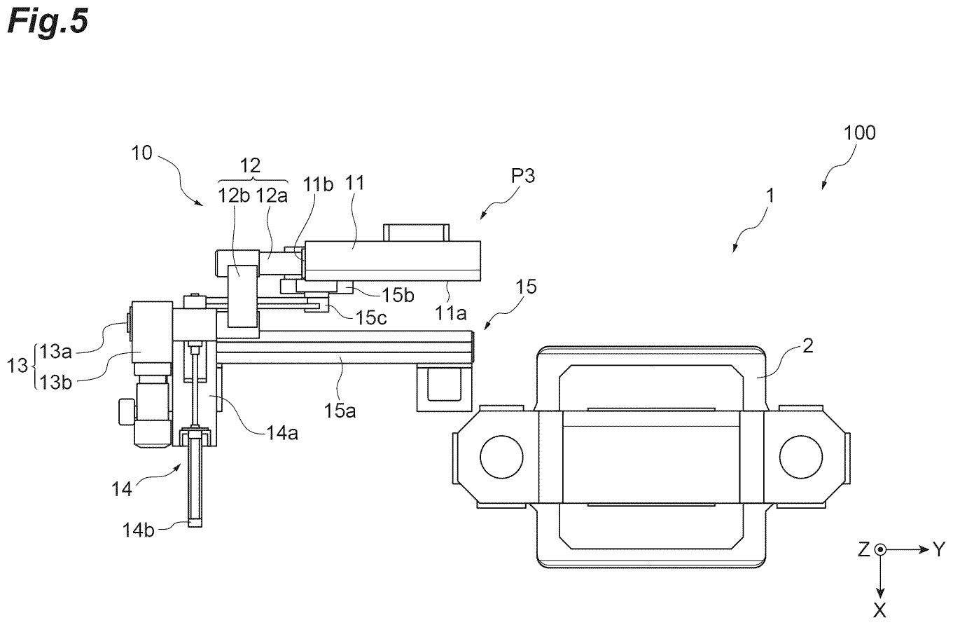

The lateral moving mechanism 15 moves the front-rear moving mechanism 14 along the Y direction together with the holding jig 11, the support arm 12, and the rotation mechanism 13. The lateral moving mechanism 15 includes a rail member 15a, a drive unit 15b, and a link mechanism 15c. The rail member 15a extends in the Y direction. The rotation mechanism 13 is movably attached to the rail member 15a. The drive unit 15b is a motor and moves the front-rear moving mechanism 14 in the Y direction. Accordingly, the holding jig 11 moves between position P2 (see FIGS. 2 and 3) and position P3 (see FIGS. 4 and 5). The link mechanism 15c is connected to the drive unit 15b and the front-rear moving mechanism 14. The drive unit 15b moves the front-rear moving mechanism 14 along the rail member 15a in the Y direction via the link mechanism 15c.

### [Operation of Molding System]

The operation of the molding system 100 will be described with reference to FIGS. 1 to 12. In the initial state of the molding system 100 shown in FIG. 1, the holding jig 11 is disposed at position P1 adjacent to the molding machine 1 in the X direction. At position P1, the holding surface 11a is oriented upward and kept parallel to the horizontal direction (X direction and Y direction). In the molding system 100, first, in the initial state, a step of disposing a core on the holding surface 11a is performed by the operator. The operator's working position is a position in the X direction where the holding jig 11 at position P1 is interposed between the molding machine 1 and the operator's working position. The operator disposes the core on the holding surface 11a and activates the suction means to hold the core by the holding jig 11. Position P1 is provided in the space in front of the molding machine 1 (cope and drag M) (hereinafter referred to as “front space”). Here, the front of the molding machine 1 is the front of the molding machine 1 as seen from the operator, which is the surface of the molding machine 1 facing the operator in the X direction. The front space is a space adjacent to the front of the molding machine 1 in the X direction. The operator's working position is also provided in the front space.

Next, a step of retracting the holding jig 11 from between the molding machine 1 and the operator is performed. The step of retracting the holding jig 11 includes a step of rotating the holding jig 11 by 90° in the clockwise direction (hereinafter referred to as “positive direction”) as seen from the negative side to the positive side in the Y direction, and a step of moving the holding jig 11 in the −Y direction. In the step of rotating the holding jig 11 by 90° in the positive direction, the holding jig 11 moves from position P1 to position P2 shown in FIGS. 2 and 3 by rotating around the rotation shaft 13a of the rotation mechanism 13 while holding the core. At position P2, the holding surface 11a is disposed parallel to the Z direction and faces the space S between the upper flask 2 and the lower flask 3 in the X direction. Position P2 is also provided in the front space. Therefore, the step of rotating the holding jig 11 by 90° in the positive direction is performed in the front space.

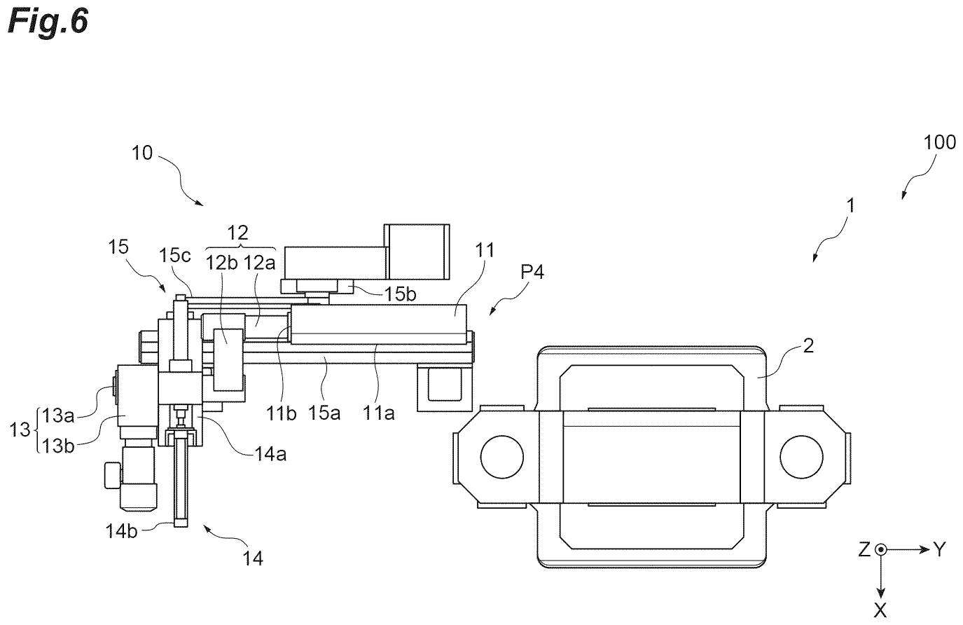

In the step of moving the holding jig 11 in the −Y direction, the holding jig 11 moves from position P2 to position P3 shown in FIGS. 4 and 5 by the lateral moving mechanism 15. As a result, the holding jig 11 retracts from between the molding machine 1 and the operator. Position P3 is provided in a space adjacent to the front space in the Y direction (hereinafter referred to as “adjacent space”). In other words, by moving the holding jig 11 in the −Y direction, the holding jig 11 moves from the front space to the adjacent space. Subsequently, a step of moving the holding jig 11 in the X direction by the front-rear moving mechanism 14 is performed, and the holding jig 11 moves from position P3 to position P4 shown in FIG. 6. Position P4 is also provided in the adjacent space. While the holding jig 11 is retracted to the adjacent space from between the operator and the molding machine 1, the operator visually inspects the cope and the drag M before setting the core. In the visual inspection, the presence or absence of foreign matter, chipping, etc., in the cope and the drag M are inspected.

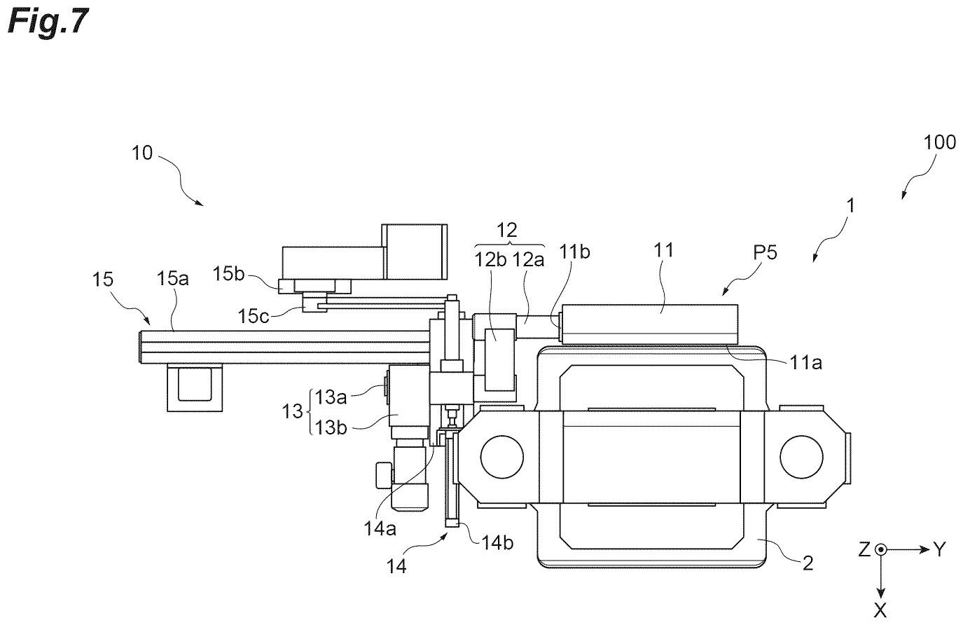

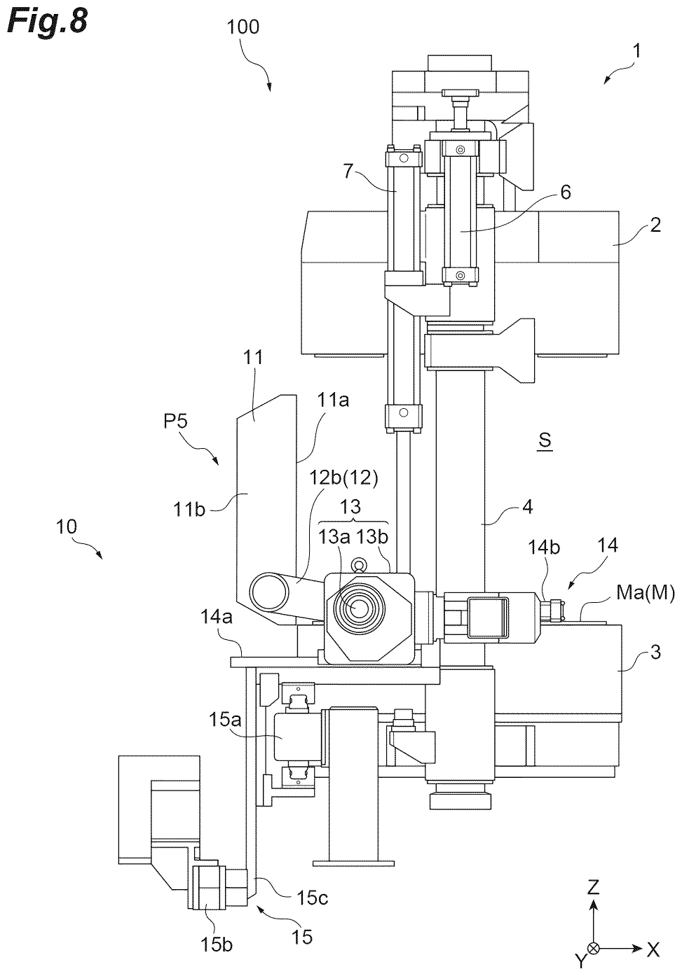

Subsequently, a step of moving the holding jig 11 in the Y direction is performed. In the step of moving the holding jig 11 in the Y direction, the holding jig 11 moves from position P4 to position P5 shown in FIGS. 7 and 8 by the lateral moving mechanism 15. At position P5, the holding surface 11a faces the space S in the X direction. By moving the holding jig 11 from position P3 to position P4 in the previous step, the distance between the holding surface 11a and the space S is shortened at position P5 compared to when it was not moved. Position P5 is also provided in the front space. In other words, by moving the holding jig 11 in the Y direction, the holding jig 11 moves from the adjacent space to the front space.

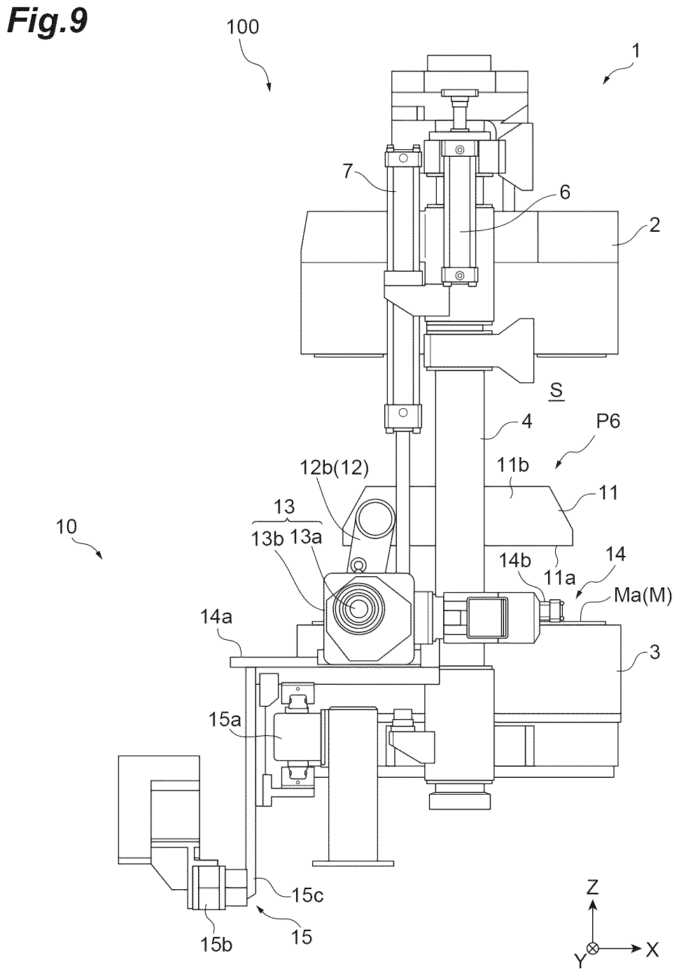

Subsequently, a step of rotating the holding jig 11 by 90° in the positive direction is performed. In the step of rotating the holding jig 11 by 90° in the positive direction, the holding jig 11 moves from position P5 to position P6 (core setting position) shown in FIG. 9 by rotating around the rotation shaft 13a of the rotation mechanism 13 while holding the core. At position P6, the holding jig 11 is disposed in the space S, and the holding surface 11a faces the upper surface Ma (product surface) of the drag M in the Z direction.

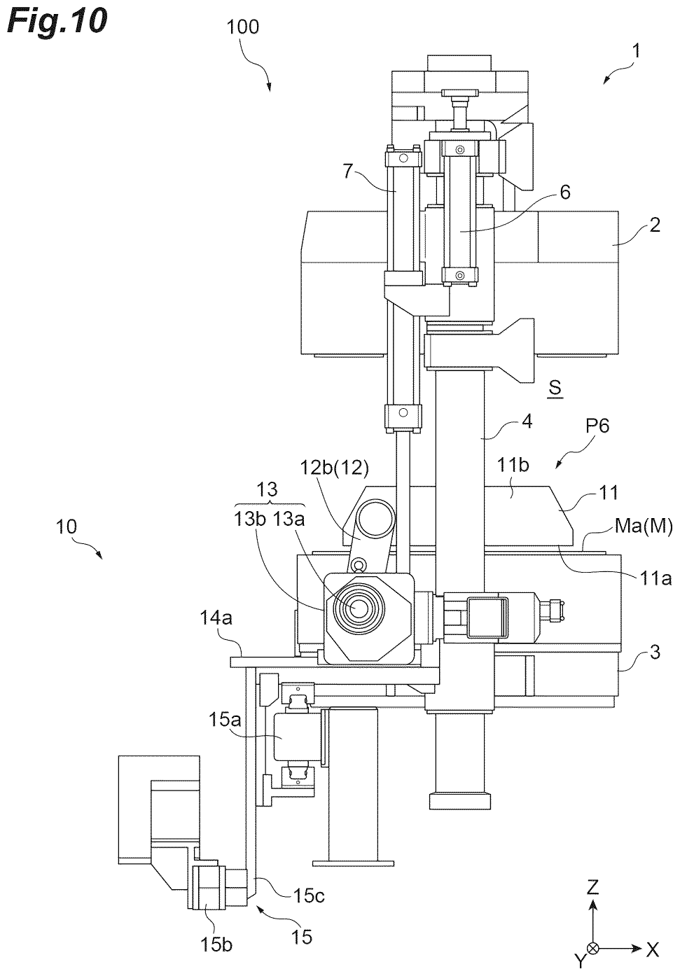

Subsequently, a step of raising the lower flask 3 together with the drag M toward the holding jig 11 by the cylinder 7 is performed. As a result, as shown in FIG. 10, the upper surface Ma of the drag M and the holding surface 11a of the holding jig 11 are brought close to each other. In this state, the holding jig 11 releases the core by stopping the operation of the suction means and sets the core in the drag M.

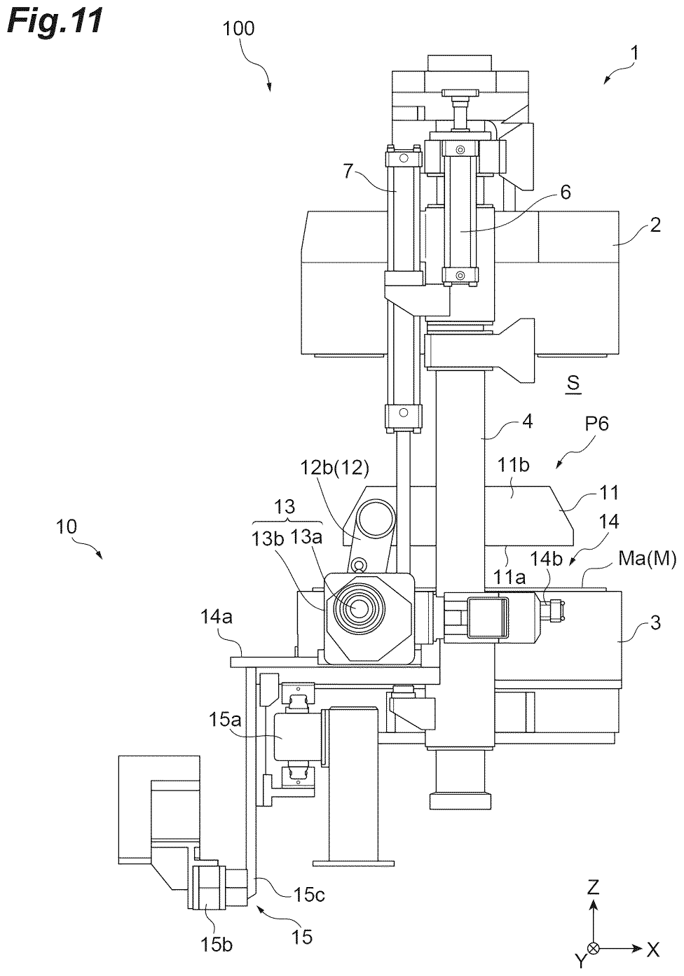

Subsequently, a step of lowering the lower flask 3 together with the drag M by the cylinder 7 is performed. As a result, as shown in FIG. 11, the drag M and the holding jig 11 are separated in the Z direction.

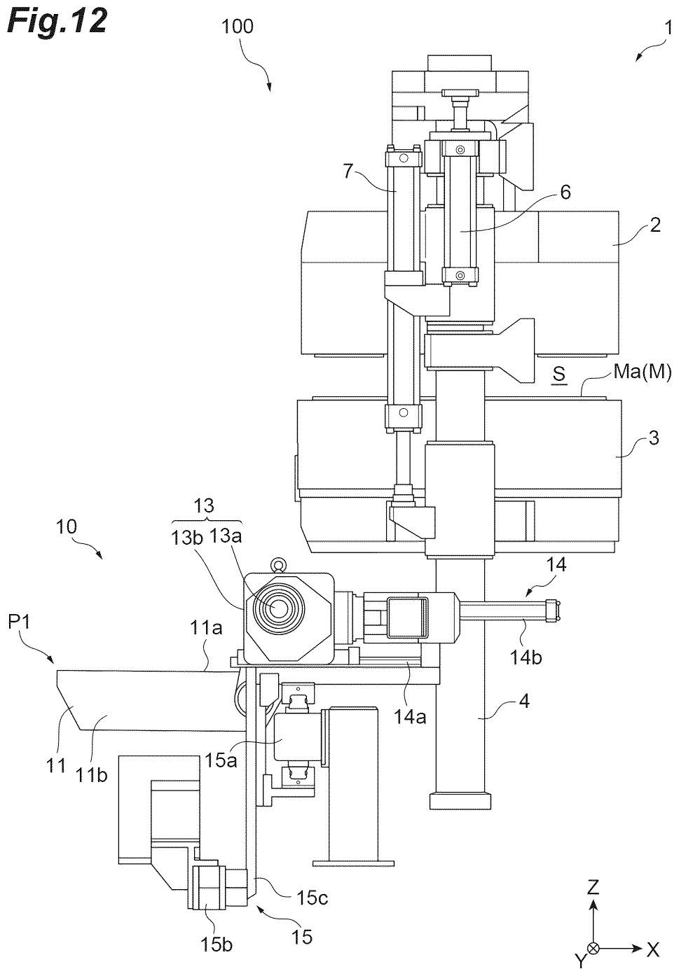

Subsequently, a step of rotating the holding jig 11 by 180° in the counterclockwise direction (hereinafter referred to as “negative direction”) as seen from the negative side to the positive side in the Y direction and a step of moving the holding jig 11 in the −X direction are performed in parallel. In the step of rotating the holding jig 11 by 180° in the negative direction, the holding jig 11 rotates around the rotation shaft 13a of the rotation mechanism 13. The step of moving the holding jig 11 in the −X direction is performed by the front-rear moving mechanism 14, and the holding jig 11 moves toward the operator. As a result, the holding jig 11 moves from position P6 to position P1 as shown in FIG. 12.

After the holding jig 11 moves out of the space S, the mold matching process is started. Here, the lower flask 3 is raised toward the upper flask 2 by the cylinder 7 to perform mold matching. Subsequently, by performing mold removal and mold ejection, the mold is manufactured.

### SUMMARY OF EMBODIMENT

According to the core setting device 10, the holding jig 11 moves between position P5 outside the space S and position P6 where the holding surface 11a faces the upper surface Ma of the drag M in the Z direction by rotating 90° around the rotation shaft 13a of the rotation mechanism 13. In other words, the holding jig 11 moves between the front space and the space S only by rotational movement. Therefore, unlike the core setting device described in Patent Document 1, which retracts the core holding means from between the drag and the cope, rotates the core holding means 180° at the retracted position, and then advances the core holding means to the position between the drag and the cope, the holding jig 11 can be moved more efficiently to set the core. This contributes to shortening the cycle time.

Since the core setting device 10 includes the lateral moving mechanism 15 that moves the holding jig 11 along the Y direction outside the space S, the holding jig 11 can be moved to a position separated from the molding machine 1. Therefore, the operator can easily perform a visual inspection of the cope and the drag M. This improves the operator's workability.

When retracting the holding jig 11 from between the molding machine 1 and the operator, the holding jig 11 rotates 90° in the positive direction in the front space (moves from position P1 to position P2). When moving the holding jig 11 from the space S to outside the space S, the holding jig 11 rotates 180° in the negative direction using the space from the space S to the front space (moves from position P6 to position P1). Thus, the holding jig 11 does not need to rotate 180° only in the front space. Therefore, in this embodiment, the operating range of the holding jig 11 in the front space can be minimized. This further improves the operator's workability and contributes to shortening the cycle time.

The holding jig 11 moves along the Y direction with the holding surface 11a disposed parallel to the Z direction by the lateral moving mechanism 15. The thickness of the holding jig 11 is smaller than the long side and the short side of the holding surface 11a. Therefore, compared to moving the holding jig 11 with the holding surface 11a facing the Z direction, the space required for moving the holding jig 11 in the X direction can be minimized.

The core setting device 10 includes the front-rear moving mechanism 14 that moves the holding jig 11 along the X direction. Therefore, the rotation radius of the holding jig 11 can be shortened, minimizing the distance between the cope and the drag M. As a result, the stroke of the cope and the drag M is shortened, reducing the time required for mold matching and other processes. This improves productivity.

The front-rear moving mechanism 14 moves the holding jig 11 along the X direction at position P3, which is separated from the space S in the Y direction. Therefore, while the operator performs a visual inspection of the cope and the drag M, the holding jig 11 can be moved along the X direction in the adjacent space. This shortens the cycle time and improves productivity.

Although various exemplary embodiments have been described above, the present disclosure is not limited to the above-described exemplary embodiments, and various omissions, substitutions, and changes may be made.

In the embodiment, the molding system 100 is exemplified, but the core setting device 10 may be used in systems other than the molding system 100. For example, the core setting device 10 may be used in a casting system including a casting machine and may set a core in a cope disposed to face a drag.

### (First Modification)

The core setting device 10 may not include the front-rear moving mechanism 14. In this case, the rotation radius of the holding jig 11 may be adjusted to move between position P1 and position P6 by rotating 180°. In this case, the operation method of the molding system 100 does not include the step of moving the holding jig 11 in the X direction by the front-rear moving mechanism 14. That is, after moving the holding jig 11 in the order of position P1, position P2, and position P3, the holding jig 11 waits at position P3 until the operator completes the visual inspection of the cope and the drag M without moving to position P4. Subsequently, the step of moving the holding jig 11 in the Y direction is performed. As a result, the holding jig 11 moves from position P3 to position P2. Subsequently, the step of rotating the holding jig 11 by 90° in the positive direction is performed. As a result, the holding jig 11 moves from position P2 to position P6. Subsequently, after setting the core in the drag M as in the embodiment, the step of rotating the holding jig 11 by 180° in the negative direction is performed. As a result, the holding jig 11 moves from position P6 to position P1 as shown in FIG. 12. Thereafter, the molding system 100 may operate in the same manner as in the embodiment.

### (Second Modification)

The molding system 100 may operate as follows. For example, the step of retracting the holding jig 11 from between the molding machine 1 and the operator may not include the step of rotating the holding jig 11 by 90° in the positive direction. That is, in the step of retracting the holding jig 11 from between the molding machine 1 and the operator, the holding jig 11 may be moved from position P1 to the −Y direction without rotating the holding jig 11, keeping the holding surface 11a parallel to the horizontal direction (X direction and Y direction). While the holding jig 11 is retracted to the adjacent space from between the molding machine 1 and the operator, the operator visually inspects the cope and the drag M before setting the core. Subsequently, the step of moving the holding jig 11 in the Y direction is performed. As a result, the holding jig 11 moves from the adjacent space to position P1. Subsequently, the step of moving the holding jig 11 in the X direction from position P1 by the front-rear moving mechanism 14 is performed. As a result, the holding jig 11 approaches the molding machine 1. Subsequently, the step of rotating the holding jig 11 by 180° in the positive direction instead of 90° is performed. As a result, the holding jig 11 moves to position P6. Thereafter, the molding system 100 may operate in the same manner as in the embodiment. Note that the step of moving the holding jig 11 in the X direction from position P1 by the front-rear moving mechanism 14 is not essential and may not be performed.

### (Third Modification)

As described above, in the second modification, the step of moving the holding jig 11 in the X direction by the front-rear moving mechanism 14 is performed after the holding jig 11 moves from the adjacent space to position P1. In contrast, in the third modification, the step of moving the holding jig 11 in the X direction by the front-rear moving mechanism 14 is performed while the holding jig 11 is retracted to the adjacent space from between the operator and the molding machine 1. In the third modification, since the holding jig 11 can be moved in the X direction in the adjacent space while the operator performs a visual inspection of the cope and the drag M, the cycle time is shortened, and productivity is improved. The third modification is otherwise equivalent to the second modification.

### (Fourth Modification)

The molding system 100 may operate as follows. For example, the step of retracting the holding jig 11 from between the molding machine 1 and the operator may not include the step of rotating the holding jig 11 by 90° in the positive direction. That is, in the step of retracting the holding jig 11 from between the molding machine 1 and the operator, the holding jig 11 may be moved from position P1 to the −Y direction without rotating the holding jig 11, keeping the holding surface 11a parallel to the horizontal direction (X direction and Y direction). Subsequently, in the adjacent space, the step of rotating the holding jig 11 by 90° in the positive direction is performed. As a result, the holding jig 11 moves to position P3. Subsequently, in the adjacent space, the step of moving the holding jig 11 in the X direction by the front-rear moving mechanism 14 is performed. As a result, the holding jig 11 moves from position P3 to position P4. While the holding jig 11 is retracted to the adjacent space from between the operator and the molding machine 1, the operator visually inspects the cope and the drag M before setting the core.

Subsequently, the step of moving the holding jig 11 from the adjacent space in the Y direction is performed. As a result, the holding jig 11 moves from position P4 to position P5. Subsequently, the step of rotating the holding jig 11 by 90° in the positive direction is performed. As a result, the holding jig 11 moves from position P5 to position P6. The holding surface 11a faces the upper surface Ma of the drag M in the Z direction. Thereafter, the molding system 100 may operate in the same manner as in the embodiment. Note that the step of moving the holding jig 11 in the X direction by the front-rear moving mechanism 14 is not essential and may not be performed. Also, in the adjacent space, the step of rotating the holding jig 11 by 90° in the positive direction and the step of moving the holding jig 11 in the X direction may be performed in reverse order.

### (Fifth Modification)

In the embodiment, the operator's working position is provided in the front space, but the working position may be provided in the adjacent space, for example. In this case, in the initial state of the molding system 100, the holding jig 11 is disposed at a position in the adjacent space, which is adjacent to the operator's working position in the X direction, not at position P1 in the front space. In this state, the operator holds the core on the holding jig 11. Subsequently, the operator moves from the adjacent space to the front space and visually inspects the cope and the drag M before setting the core. Subsequently, the operator moves outside the movable range of the core setting device 10.

Subsequently, the step of moving the holding jig 11 in the Y direction is performed. As a result, the holding jig 11 moves from the adjacent space to position P1. This step is performed when there is no operator within the movable range of the core setting device 10. For example, a push button for operating the core setting device 10 is provided outside the movable range of the core setting device 10. In addition, the core setting device 10 is configured to operate after confirming that there is no operator within the movable range of the core setting device 10 using an area sensor or the like.

Subsequently, in the front space, the step of rotating the holding jig 11 by 180° in the positive direction is performed. As a result, the holding jig 11 moves to position P6. Thereafter, the molding system 100 may operate in the same manner as in the embodiment. Note that the step of moving the holding jig 11 in the X direction from position P1 by the front-rear moving mechanism 14 may be performed between the step of moving the holding jig 11 in the Y direction and the step of rotating the holding jig 11 by 180° in the positive direction. Also, the step of moving the holding jig 11 in the X direction by the front-rear moving mechanism 14 may be performed in the adjacent space before the step of moving the holding jig 11 in the Y direction.

### (Sixth Modification)

As described above, in the fifth modification, the step of rotating the holding jig 11 by 180° in the positive direction is performed in the front space. In contrast, in the sixth modification, the step of rotating the holding jig 11 by 90° in the positive direction in the adjacent space and the step of rotating the holding jig 11 by 90° in the positive direction in the front space are performed. The sixth modification is otherwise equivalent to the fifth modification. In the sixth modification, while the operator performs a visual inspection of the cope and the drag M, the step of rotating the holding jig 11 by 90° in the positive direction is performed in the adjacent space. As a result, the holding jig 11 moves to position P4. Subsequently, the operator moves outside the movable range of the core setting device 10.

Subsequently, the step of moving the holding jig 11 in the Y direction is performed. As a result, the holding jig 11 moves from the adjacent space to position P5. This step is performed by the same interlock control as in the fifth modification when there is no operator within the movable range of the core setting device 10. Subsequently, in the front space, the step of rotating the holding jig 11 by 90° in the positive direction is performed. As a result, the holding jig 11 moves from position P5 to position P6. Thereafter, the molding system 100 may operate in the same manner as in the embodiment.

### SUMMARY OF EMBODIMENTS OF THE PRESENT DISCLOSURE

The present disclosure includes the following aspects.

(Clause 1) A core setting device according to an aspect of the present disclosure is a core setting device that sets a core in a drag disposed to face a cope in the vertical direction. The core setting device includes a holding jig having a holding surface for holding the core, a rotation mechanism having a rotation shaft parallel to a first direction orthogonal to the vertical direction and configured to rotate the holding jig, and a first moving mechanism configured to move the holding jig along the first direction outside the space between the cope and the drag. The holding jig is configured to move between the outside of the space and a core setting position where the holding surface faces the upper surface of the drag in the vertical direction by rotating around the rotation shaft.

In this core setting device, the holding jig moves between the outside of the space between the cope and the drag and the core setting position by rotating around the rotation shaft. In other words, the holding jig can move between the outside of the space and the core setting position inside the space only by rotational movement. Since the holding jig can be moved efficiently to set the core, this contributes to shortening the cycle time. Moreover, since the holding jig can be moved to a position separated from the cope and the drag, the operator can easily perform a visual inspection of the cope and the drag. This improves the operator's workability. Furthermore, the holding jig does not need to rotate 180° in the front space of the upper and drags. The front space of the upper and drags may be provided with a working position where the operator sets the core on the core holding means or visually inspects the drag and the cope. Even in this case, since the operating range of the core setting device in the front space of the upper and drags can be minimized, the operator's workability can be further improved.

(Clause 2) In the core setting device according to Clause 1, the holding jig may move along the first direction with the holding surface disposed parallel to the vertical direction by the first moving mechanism. In this case, if the thickness of the holding jig is smaller than the size of the holding surface, the space required for moving the holding jig can be minimized compared to moving the holding jig with the holding surface facing the vertical direction.

(Clause 3) The core setting device according to Clause 1 or 2 may further include a second moving mechanism configured to move the holding jig along a second direction orthogonal to the vertical direction and the first direction. In this case, the rotation radius of the holding jig can be shortened, minimizing the distance between the cope and the drag. As a result, the stroke of the cope and the drag is shortened, reducing the time required for mold matching and other processes. This improves productivity.

(Clause 4) In the core setting device according to Clause 3, the second moving mechanism may move the holding jig along the second direction at a position separated from the space in the first direction. In this case, while the operator performs a visual inspection of the cope and the drag, the holding jig can be moved along the second direction. This shortens the cycle time and improves productivity.

What is claimed is:

1. A core setting device that sets a core in a drag disposed to face a cope in a vertical direction, the core setting device comprising:
a holding jig having a holding surface for holding the core;
a rotation mechanism having a rotation shaft parallel to a first direction orthogonal to the vertical direction and configured to rotate the holding jig; and
a first moving mechanism configured to move the holding jig along the first direction outside a space between the cope and the drag, wherein
the holding jig is configured to move between outside the space and a core setting position where the holding surface faces an upper surface of the drag in the vertical direction by rotating around the rotation shaft.

2. The core setting device according to claim 1, wherein the holding jig is configured to move by the first moving mechanism along the first direction with the holding surface disposed parallel to the vertical direction.

3. The core setting device according to claim 1, further comprising a second moving mechanism configured to move the holding jig along a second direction orthogonal to the vertical direction and the first direction.

4. The core setting device according to claim 3, wherein the second moving mechanism is configured to move the holding jig along the second direction at a position separated from the space in the first direction.
